(19) United States
(12) Patent Application Publication
(10) Pub. No.: US 2011/0303254 A1
(43) Pub. Date: Dec. 15, 2011

(54) TEMPORARY STRUCTURE INSULATING SYSTEM

(76) Inventors: Rick G. Tucker, Woodstock, GA (US); Richard A. West, LaGrange, OH (US)

(21) Appl. No.: 13/155,521

(22) Filed: Jun. 8, 2011

Related U.S. Application Data
(60) Provisional application No. 61/353,891, filed on Jun. 11, 2010.

(51) Int. Cl. E04H 15/02; E04B 1/16; B05D 3/10

(52) U.S. Cl. 135/96; 427/300; 264/31

(57) ABSTRACT

The present invention relates to a method, processes and system that allows thermal insulating and waterproofing of temporary and/or portable structures in such a manner that the underlying structures are insulated and waterproofed. Moreover, this system provides a rigid outer structure which allows the underlying structure to be removed and reused after the insulation and waterproofing system has been installed, leaving behind a rigid, insulated and waterproof physical structure.

### CROSS-REFERENCE TO RELATED APPLICATION

This application claims domestic priority from commonly owned, copending, U.S. Provisional Patent Application Ser. No. 61/353,891, filed 11 Jun. 2010, the disclosure of which is hereby incorporated herein by reference.

### FIELD OF THE INVENTION

The present invention relates to a method, processes and system that allows thermal insulating and waterproofing of temporary and/or portable structures in such a manner that the underlying structures are insulated and waterproofed. Moreover, this system provides a rigid outer structure which allows the underlying structure to be removed and reused after the insulation and waterproofing system has been installed, leaving behind a rigid, insulated and waterproof physical structure.

### BACKGROUND OF THE INVENTION

Structures made from polyurethane foam sprayed onto inflatable support forms are known. See for example U.S. Pat. Nos. 3,503,167, 3,668,287, 4,678,157 and 7,506,483, the disclosures of which are hereby incorporated herein by reference.

### SUMMARY OF THE INVENTION

Since 2008 Honeywell International Inc. has sold a polyurethane material for the manufacture of insulation under the trademark Terrastrong®. This material has been found to be useful in creating the portable temporary structure insulating system (PTSIS) of the present invention. While this material is currently the preferred polyurethane material for this invention, other similar materials are expected to be useful as well.

In one embodiment, the PTSIS allows a temporary structure (such as a tent) to be insulated and/or waterproofed by the following process steps:

(a) providing a rigid support structure;

(b) surrounding the support structure with a shroud material;

(c) optionally coating the shroud material with a non-stick coating;

(d) coating the shroud material with an insulating layer of polyurethane material; and

(e) curing the polyurethane material.

Optionally, one or more additional layers can be applied to the inner or outer surfaces of the cured polyurethane layer, for example additional treatments if desired. For example, following removal of the shroud and the support structure, the inner surface of the polyurethane material can be coated with a fire retardant composition. Likewise, the outer surface can receive one or more additional coatings or surface treatments, if desired. For example, if the polyurethane material does not provide a waterproof surface, one or more waterproofing materials may be added to the outer surface.

In this process, the temporary structure can have any size; from a simple lean-to or tent size, up to a livestock barn or aircraft hanger size. The present invention requires a rigid support frame which holds the shape of the structure while the other steps of the process are being conducted. After the polyurethane material has cured, the rigid support frame can be removed, by physical or mechanical means, if desired.

Materials for the temporary structure can be man-made materials such as tent cloth, other fabric materials, plastic materials, metal, cardboard, or the like. Alternatively or additionally, natural materials can be used for the temporary structure, including tree branches, grass bundles, mud, snow, and the like. Combinations of man made and natural products can also be employed.

In some embodiments of the process, the shroud material is a flexible material, which conforms, at least partially, to the shape of the underlying temporary structure. Such materials include fabric materials, such as nylon and the like; plastic sheets, and similar materials.

The shroud can be simply draped over the existing structure, or it can be designed to form fit over the existing structure, either in advance (e.g., be pre-sized to fit) or the shroud can have negative pressure applied from within the existing structure to create the form fit nature by application of a vacuum. Likewise, the shroud can be fit over an existing structure by application of positive pressure, either of the shroud itself or a bladder located under the shroud, such that the shroud is inflated around the existing structure.

In some embodiments of the process, the shroud material is a rigid material, such as metal sheets; cardboard, and the like. Combinations of flexible and rigid materials can likewise be employed.

If the underlying support structure and/or the shroud material are to be removed after the polyurethane material has been cured, a release agent or other non-stick coating material may be used to enable easy removal of these materials. Such materials can be applied in numerous ways, and at various times before the spray polyurethane material. For instance, a shroud material could be coated during or after its manufacture. Release agents are well known, as they provide a non-stick coating which keeps the cured polyurethane material from sticking to the shroud material or the underlying support structure. Other non-stick coatings for the polyurethane material include other film coatings such as polyethylene film, and the like.

Depending upon the size and weight of the insulated and/or waterproofed structure formed by the process of this invention, the structure may also be considered as being portable—capable of being moved from one location to another. Such structures can also serve as temporary housing in situations such as military conflicts, shelter for use in remote regions, or emergency shelter after fires, floods, earthquakes, hurricanes, tornados, and the like.

Once the rigid insulating and waterproofing shell has been allowed to cure, the portable temporary structure can be physically removed and reused if desired. Removal of the shroud can be accomplished simply by pulling it away from the cured polyurethane insulating material. If the temporary structure comprises a tent or similar structure coated with a non-stick release agent material on the outside surface, physical labor will likewise suffice to break down the tent components for removal from the cured polyurethane shell. In the alternative, the original structure can remain in place, serving the same function as before the waterproofing and insulating treatment.

The PTSIS provides rapid and cost effective construction of a rigid insulated and waterproof structural system. The PTSIS uses a combination of fabrics and/or release agent fabric coatings to allow the portable structure to be coated with polyurethane foam, such that the polyurethane foam does not adhere to the substrate the foam is being applied to. The polyurethane foam provides insulating characteristics to the structure. One or more additional coatings can be used to provide additional waterproofing characteristics if desired.

Military structures that are especially suitable for treatment by the process of this invention include, but are not limited to tents, SWA huts; Quonset huts; SPRUNGs, hangers and the like. Guard stations can be added to existing structures or built as free-standing structures using this technology. While the polyurethane material is curing, these structures can be camouflaged with dirt, sand, rocks, and other local materials, to make them less visible from aerial surveillance.

### BRIEF DESCRIPTION OF THE DRAWINGS

FIG. 1 shows a typical prior art temporary or portable structure in the form of a military tent used in field operations.

FIG. 2 shows a typical military tent with spray foam insulation applied directly to the tent surface. A window and a door have been added.

FIG. 3 shows an inflated bladder in a finished size with a fabric shroud cover ready for the application of spray foam insulation.

FIG. 4 shows a blower which is inflating a bladder.

FIG. 5 shows a polyurethane spray foam insulation being applied directly to a fabric shroud which is over an inflated bladder.

FIG. 6 shows a structure after the foam has been applied to the fabric and is fully cured but not yet coated with an additional weather resistant coating.

FIG. 7 shows a fabric shroud (dark surface) being peeled from the cured foam (light surface) inside the structure after the bladder has been deflated and removed.

FIG. 8 is the interior of a finished foam structure after the fabric shroud has been removed, and the foam surface has been coated with a fire resistant, white coating.

### DETAILED DESCRIPTION OF THE INVENTION

As illustrated in the drawings accompanying this disclosure, the PTSIS allows a thermal insulating and waterproofing material to be applied to a temporary or portable structure in a manner that the underlying physical structures can be removed and reused after the insulation and waterproofing system has been installed, leaving behind an insulated and waterproofed physical structure.

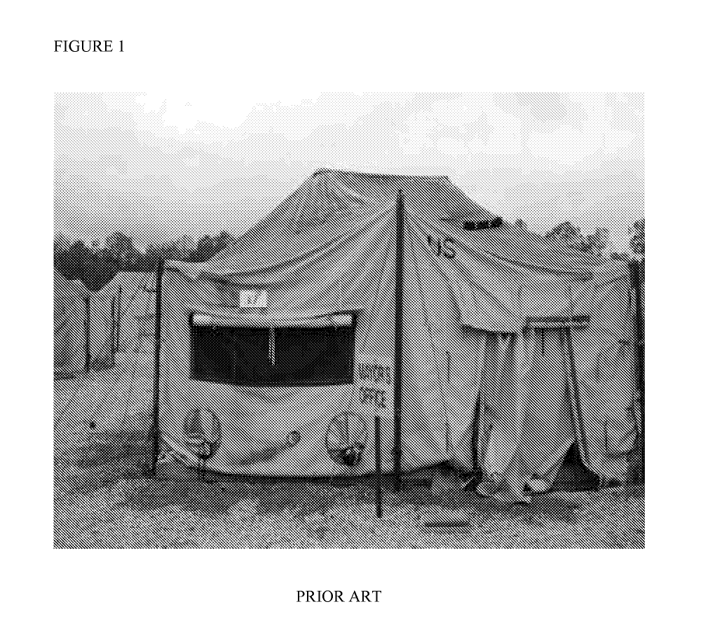

FIG. 1 shows a typical prior art temporary or portable structure in the form of a military tent used in field operations. It should be noted that before a tent of this type can treated with any coating material, such as a polyurethane insulation material, it should first be cleaned. Cleaning a military tent is labor intensive and potentially dangerous work, for both the tent and the personnel doing the cleaning. However, once dirt has been removed from the tent, it can be treated, if desired, with a non-stick coating release agent, and spray coated with a polyurethane insulation material to make an insulated and/or waterproofed structure.

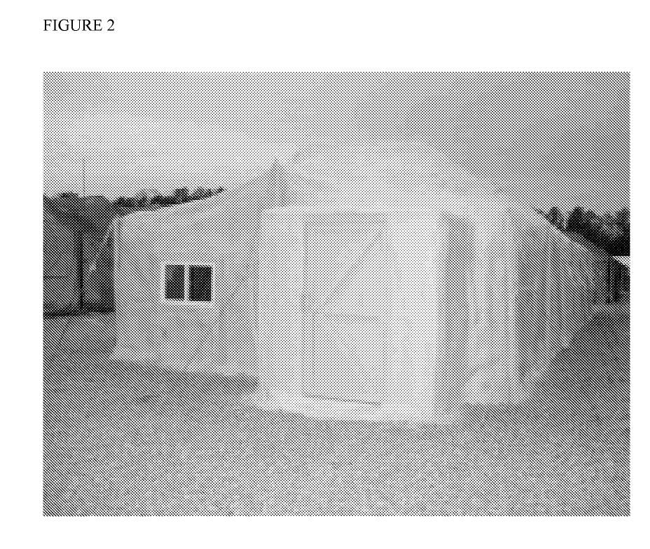

FIG. 2 shows a typical military tent with spray foam polyurethane insulation material applied directly to the tent surface. This generally renders the tent unsuitable for movement after this treatment. As shown, a window and a door have been added to the insulated tent.

The use of a shroud material, as shown in the next several drawings, eliminates the need to clean the underlying structure (e.g., tent), thereby reducing the time required to provide the desired insulated and/or waterproofed structure. Depending upon the material used for the shroud, additional benefits are possible—beyond waterproofing and insulating properties, as discussed below.

For example, in some embodiments, the shroud fabric can comprise ballistic fibers or fabrics. Known ballistic fibers include, for example, materials such as aramid and high-modulus polyethylene (HMPE) fibers and textiles. These materials are especially useful in military applications of the invention.

Honeywell's ballistic fibers and fabrics include Gold Shield, Spectra Shield® and Spectra Shield II materials. Spectra Shield and Spectra Shield II use Honeywell's super-strength Spectra® fiber, which, pound for pound, is 15 times stronger than steel yet light enough to float. The Spectra Shield® II ballistic composite material uses HMPE fibers. The Gold Shield® armor material uses aramid fiber.

DuPont's Kevlar® aramid ballistic materials are offered in several versions to protect against bullets, sharp objects, shrapnel, or a combination of threats. Kevlar XP™, a woven/laminated construction that offers attributes of both woven and unidirectional technologies.

DSM Dyneema makes Dyneema® ballistic fibers and yarns, which comprise an ultra-high-molecular-weight polyethylene (UHMWPE), for use as ballistic materials. Specific products include HB51 and HB26. Warwick Mills uses Dyneema® and other high-performance fibers to provide bullet resistance and blunt trauma protection in soft armor incorporating its TurtleSkin® SoftPlate technology.

Milliken & Company makes Tegris™ polypropylene (PP) thermoplastic composite as a ballistic textile. This technology is based on a coextruded PP tape yarn with a highly drawn core sandwiched between layers of lower-melt polymer.

Innegrity LLC offers Innegra™ S PP-based ballistic materials for both hard and soft armor applications. Other ballistic fabric products include fiber products based on nanotechnology. Nanocomp Technologies Inc., produces fibers made from carbon nanotubes, in yarn and nonwoven sheet form.

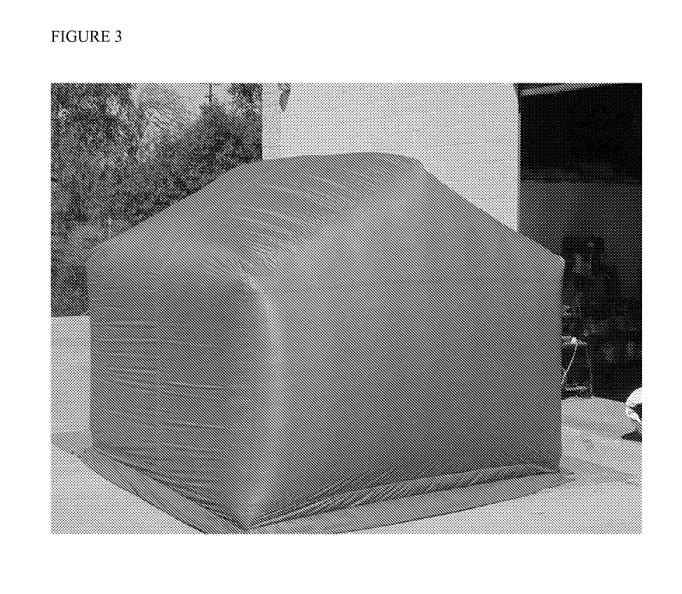

FIG. 3 shows an inflated fabric nylon shroud ready for the application of spray foam polyurethane insulation material. The fabric shroud is such that it allows the foam insulation to bond and cure fully without blisters or distortion yet will release from the foam after releasing the pressure. Here, the fabric shroud is sized to fit over the existing structure, using the positive pressure of a blower device.

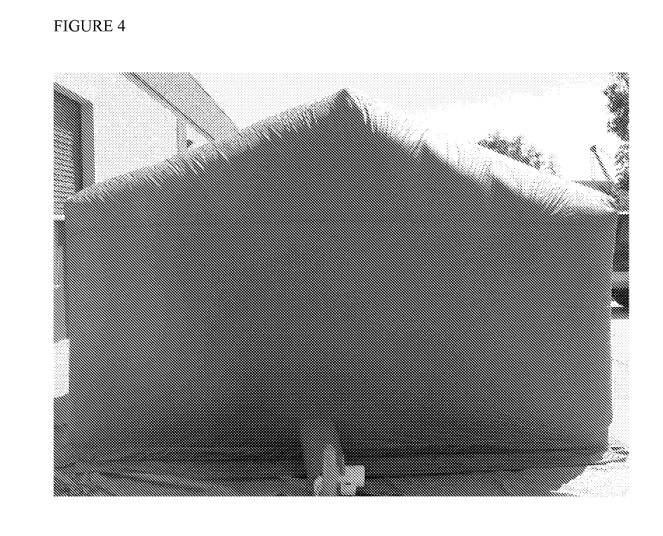

FIG. 4 shows a blower which is inflating the shroud. Note, depending upon the material used for the shroud, either the shroud itself can be inflated by positive pressure, if the shroud is air-tight; or an inflatable member (e.g., a bladder) can be used to rigidify the shroud by pressure applied to that member under the shroud.

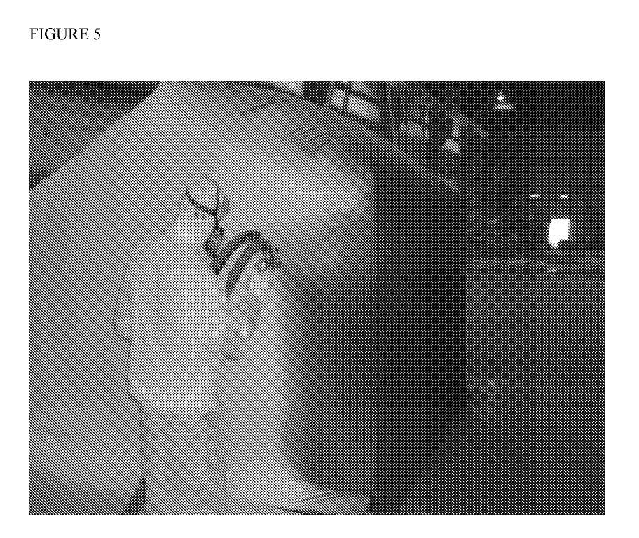

FIG. 5 shows the application of the spray foam polyurethane insulation material, applied directly to the fabric shroud which is over an inflated bladder (not shown). The spray foam polyurethane insulation material may be applied at any desired thickness level, for example ¼ inch thick, ½ inch thick, 1 inch thick, two inches thick, and more, if desired. For most military applications, a range of from 2 to 6 inches is employed. Other applications can have greater or lesser thicknesses, as desired for particular applications. Spraying of the foam polyurethane insulation material is done by conventional equipment and methods. See for example, U.S. Pat. No. 6,347,752, the disclosure of which is hereby incorporated herein by reference.

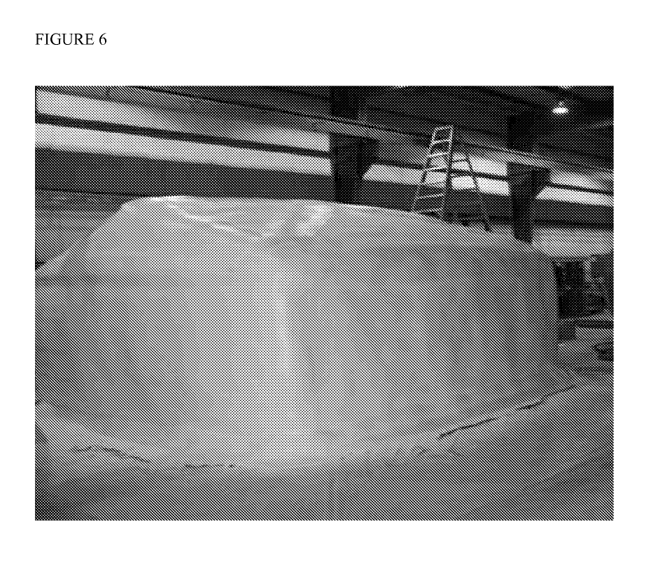

FIG. 6 shows the structure after the spray foam polyurethane insulation material foam has been applied to the fabric and has been fully cured; but this material has not yet been coated with a weather resistant coating. The addition of a weather resistant coating is an option when the polyurethane insulation material does not provide a waterproof coating for the structure. Suitable weather resistant elastomeric coatings and membranes and the like; as well as, stucco, acrylics, silicones, urethanes, polyurea coatings, paints, and the like.

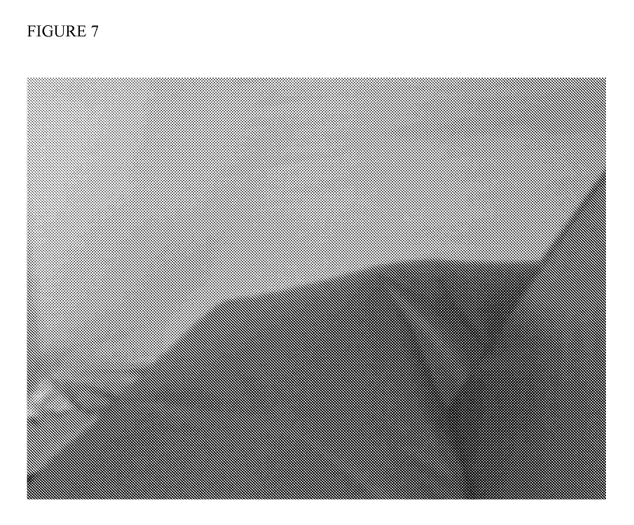

FIG. 7 shows the fabric shroud (dark material) being peeled away from the interior surface of the cured foam polyurethane insulation material. The release agent allows the shroud to be removed simply by pulling it away, by hand, from the cured spray foam polyurethane insulation material. Mechanical aids can be employed if needed.

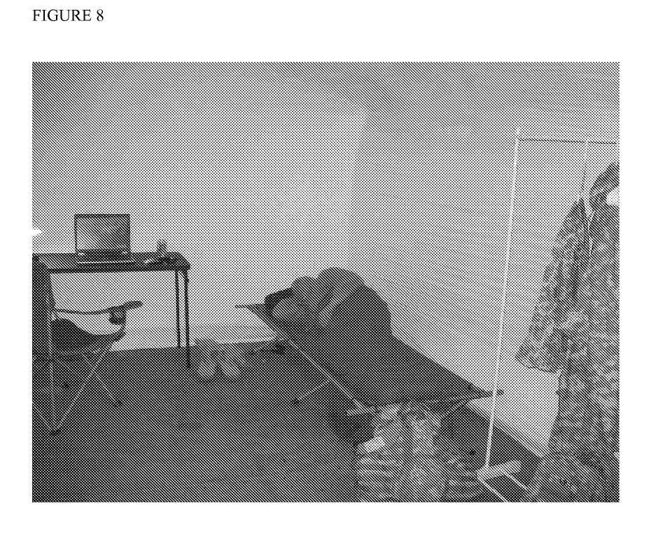

FIG. 8 shows the interior of a finished foam structure after the fabric shroud has been removed and the inner surface of the cured foam polyurethane insulation material has been coated with a fire resistant, white coating. Suitable fire resistant coatings include intumescent coating and paints, stucco, parge and masonry coatings, gypsum, silicone, and the like. These can be sprayed onto the inner surface, brush painted onto the inner surface, or used on both the inner and outer surfaces of the cured spray foam polyurethane insulation material.

Since 2008 Honeywell International Inc. has sold a polyurethane material for the manufacture of insulation under the trademark Terrastrong®. This material has been found to be useful in creating the portable temporary structure insulating system (PTSIS) of the present invention. Other materials that may likewise be useful in this invention, include, but are not limited to, the following examples; polyester resin and fiberglass fiber shell material, isocyanurate spray foams, polyurea, high density elastomers, and cementious coverings, and the like. Preferably, the insulating material is polyurethane insulating material, most preferably, Honeywell's Terrastrong® material.

Blowing agents are typically employed for the spraying of polyurethane materials and such blowing agents preferably have low global warming potential (GWP) and/or low ozone depletion potential (ODP). Blowing agents preferably have an ODP of not greater than about 0.5 and even more preferably an ODP of not greater than about 0.25, most preferably an ODP of not greater than about 0.1; and/or a GWP of not greater than about 150, and even more preferably, a GWP of not greater than about 50. One commercial blowing agent with zero ODP is Enovate® from Honeywell (HFC-245fa), and this is the preferred material used in the present invention.

This invention exploits one of the key properties of the polyurethane spray foam, namely the ability to be applied as a sprayable liquid and to foam to the shape of the substrate. As for blowing agents, all liquid blowing agents can be used—HFC-245fa, HFC-365mfc, HFC-365mfc/HFC-227ea mixtures, HCFC-141b, HCFO-1233zd(E) or 1233zd(Z), HFO-1336mzzm(Z), water and less preferred—cyclopentane, isopentane, normal pentane, methyl formate, methylal, trans-1,2-dichloroethylene and gaseous blowing agents like HFC-134a, HFO-1234ze(E), and CO₂. Any and all mixtures of these agents will also be suitable.

### Coating a Portable Structure

In this embodiment, the first step makes use of a fabric shroud that is applied to the exterior of the portable structure, such that the entire structure is completely covered. Preferred fabrics for this step include vinyl, nylon, PVC, cotton, rayon, canvas, and similar non-porous, non stretch materials that will accept a release agent or will simply allow the foam to cure fully without distortion, and then release from the cured foam.

In a second step, a non-stick release agent coating may be applied to the fabric shroud material in a uniform manner, coating the entire shroud substrate. This combination of the fabric shroud and the non-stick release agent coating allows the newly applied insulation and waterproofing material to be released from the portable structure. Suitable non-stick release agent coatings for use in this step include silicones that contain zero hydrocarbon solvents. The preferred release agent used in this invention is silicone commercially available from WDG Company, LaGrange, Ohio.

After the non-stick release agent coating has been applied to shroud substrate, the polyurethane insulation and waterproofing system is sprayed onto the shroud material, forming a uniform coating from about two to six inches thick. The most preferred polyurethane material is Terrastrong® closed cell sprayed polyurethane foam with an in place density between 2 and 3.5 lbs per cubic foot, a flame spread of less than 25, and a smoke development of less than 450, commercially available from Honeywell International Inc. However, as described above, other polymeric insulating and waterproofing materials, or combinations of such materials, may also be used.

Once the rigid insulating and waterproofing shell has been allowed to cure, the portable temporary structure can be physically removed and reused if desired. Removal of the shroud can be accomplished simply by pulling it away from the cured polyurethane insulating material as shown in FIG. 7. If the temporary structure comprises a tent or similar structure with a non-stick material on the outside surface, physical labor will likewise suffice to break down the tent components for removal from the cured polyurethane shell. In the alternative, the original structure can remain in place, serving the same function as before the waterproofing and insulating treatment.

If the rigid structure is removed, the remaining polyurethane structure will be an insulated and waterproof core shell—which by itself can serve as a modular structure, having the following properties; a sustainable structure having an expected service life of from 10 to 20 years (maintenance free) before any re-coating is required; light weight and portable, as the coating weighs less than about 2 pounds per square foot; and thermally efficient; the air and moisture barrier has an R-value of 6/inch. As described above, fireproofing of the interior surface may be accomplished using conventional technologies.

In the event there is an existing temporary structure (e.g., a tent), the existing structure could have the non-stick release agent coating applied directly to the exterior surfaces and then the foam insulation/waterproofing material can be applied directly over the structure coated with the non-stick release agent coating. This allows the existing structure to be removed and the cured foam structure to remain in place.

While the present invention has been particularly shown and described with reference to preferred embodiments, it will be readily appreciated by those of ordinary skill in the art that various changes and modifications may be made without departing from the scope of the invention. It is intended that the claims be interpreted to cover the disclosed embodiment, those alternatives which have been discussed above and all equivalents thereto.

What is claimed is:

1. A process for forming an insulated temporary structure comprising the steps of:
(a) providing a rigid support structure;
(b) providing the support structure with an outer shroud material;
(c) optionally coating the shroud material with a non-stick coating;
(d) coating the shroud material with an insulating layer of polyurethane material; and
(e) curing the polyurethane material to form an insulated temporary structure.

2. The process of claim 1, wherein the cured polyurethane material further waterproofs the insulated structure.

3. The process of claim 1, wherein a waterproofing material is applied to waterproof the insulated structure.

4. The process of claim 1, wherein the shroud material comprises a flexible material.

5. The process of claim 4, wherein the shroud material comprises a ballistic material.

6. The process of claim 1, wherein the shroud material comprises a rigid material.

7. The process of claim 1, wherein the insulated structure is portable.

8. An insulated structure formed by the process of claim 1.

9. A waterproof and insulated structure formed by the process of claim 3.

10. The process of claim 1, further comprising the step of removing the rigid support structure after the curing of the polyurethane material.

11. An insulated structure formed by the process of claim 10.

12. A process for forming a waterproofed and insulated temporary structure comprising the steps of:
(a) providing a temporary fabric structure;
(b) optionally coating the fabric structure with a release agent material;
(c) coating the fabric with a polyurethane material; and
(e) curing the polyurethane coating to provide a waterproofed and insulated temporary structure.

13. A waterproof and insulated structure formed by the process of claim 12.

14. The process of claim 12, further comprising the step of removing the temporary structure after the curing of the polyurethane coating.

15. A waterproof and insulated structure formed by the process of claim 14.

16. A process for forming a waterproofed and insulated portable structure comprising the steps of:
(a) providing a portable structure;
(b) coating the portable structure with a non-stick coating material;
(c) coating the non-stick treated material with a polyurethane material; and
(e) curing the polyurethane coating to provide a waterproofed and insulated portable structure.

17. A waterproof and insulated structure formed by the process of claim 16.

18. The process of claim 16, further comprising the step of removing the portable structure after the curing of the polyurethane coating.

19. A waterproof and insulated structure formed by the process of claim 18.

20. A process for forming an insulated temporary structure comprising the steps of:
(a) providing a rigid support structure;
(b) coating the support structure with a shroud material which includes a non-stick property on the outer surface;
(c) coating the outer surface of the shroud material with an insulating layer of polyurethane material; and
(d) curing the polyurethane material to form an insulated temporary structure.
